(19) United States
(12) Patent Application Publication
(10) Pub. No.: US 2014/0375083 A1
(43) Pub. Date: Dec. 25, 2014

(54) The Dual (day/night) Power Window system for automobiles, the DPW system

(71) Applicant: Franklin Tejeda, New York, NY (US)

(72) Inventor: Franklin Tejeda, New York, NY (US)

(21) Appl. No.: 13/921,459

(22) Filed: Jun. 19, 2013

(51) Int. Cl. B60J 1/00; B62D 21/15; B60J 7/043; B60J 1/18

(52) U.S. Cl. CPC B60J 1/001; B60J 1/18; B62D 21/152; B60J 7/043
USPC 296/187.11; 296/216.01; 49/404

(57) ABSTRACT

The Dual (day/night) Power Window system (DPW) for automobiles is comprised of two window glasses per door. It has an outer/clear window and an inner window tinted to the automobile owner's liking. It is designed to give the occupant(s) of the automobile an instant choice on whether the occupant(s) want a clear, ambient view or if the occupant(s) wants to be protected from too much ambient light, whether the occupant is the driver or a passenger.

### BACKGROUND OF THE INVENTION

1. Field of the Invention

The field of the invention of the Dual (day/night) Power Window system for automobiles or the DPW system is directed towards and falls under the subject matter of Automobile Power Windows.

2. Description of the Related Art

The Automobile Power Window, when accompanied with window tinting, is a combination of existing technologies that provide automobile passengers with protection from excessive daylight. The problem with that combination of technologies on an automobile is that when it is driven at times when there is no excessive daylight, the driver's ability to see the road and his/her surroundings is jeopardized, thus causing an unsafe driving condition. This problem or condition is immediately resolved by utilizing the Dual (day/night) Power Window system for automobiles, the DPW system. Since the DPW system utilizes two power windows instead of one, a tinted window and a clear window, the passengers have an immediate choice as to which window they will want to use, depending on the amount of ambient light there is present at that particular moment.

### BRIEF SUMMARY OF THE INVENTION

The Dual (day/night) Power Window system, the DPW system for automobiles is comprised of two window glasses per door. It has an outer/clear window and an inner/tinted window tinted to the automobile owner's liking. The inner window can be either tinted from the manufacturer or tinted by applying tinted paper to it. The DPW system is designed to give the occupant(s) of the automobile an instant choice on whether the occupant(s) want a clear, ambient view or if the occupant(s) wants to be protected from too much ambient light, whether or not the occupant is the driver or a passenger.

### BRIEF DESCRIPTION OF THE SEVERAL VIEWS OF THE DRAWINGS

### Substitute Specifications Contain No New Matter

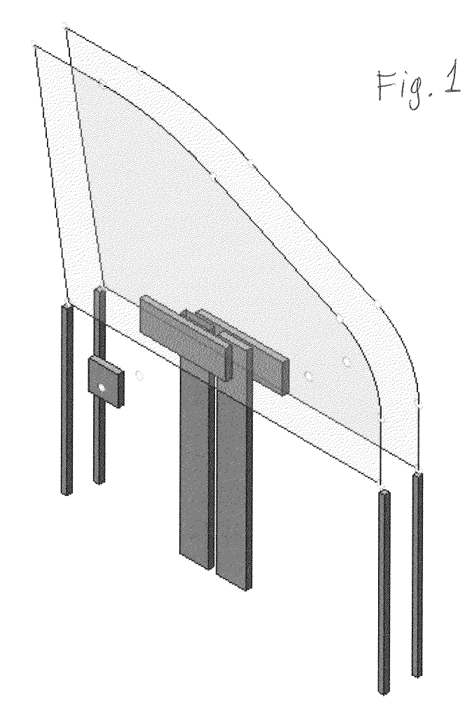

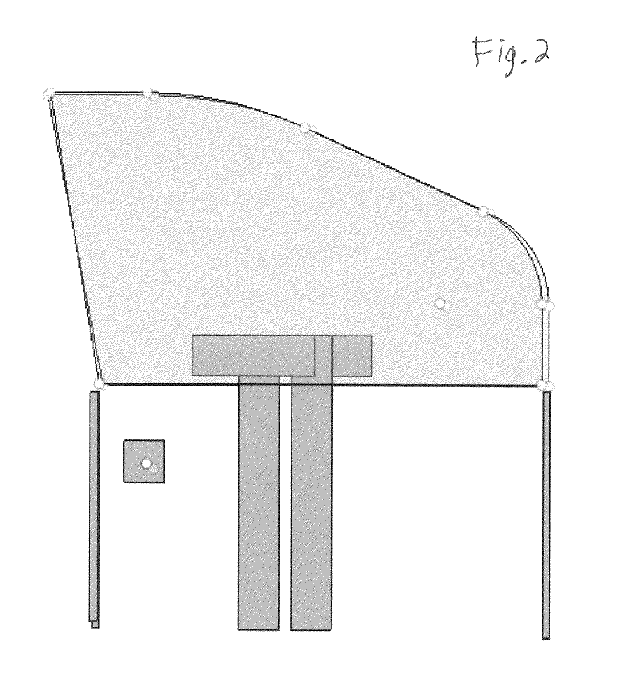

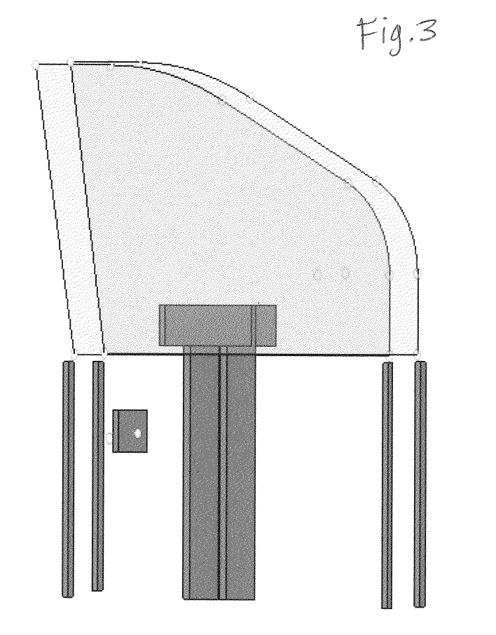

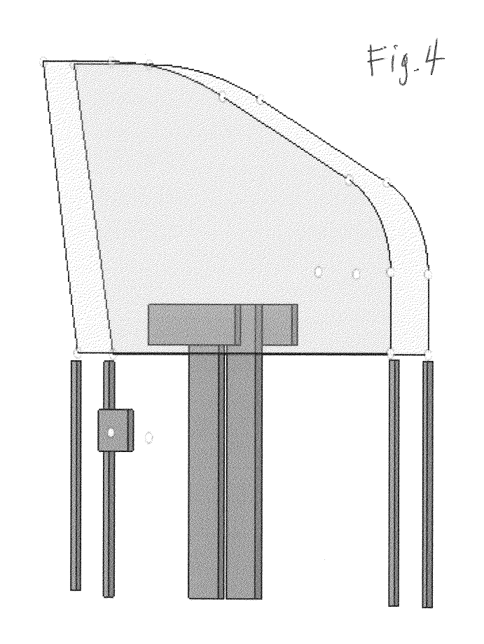

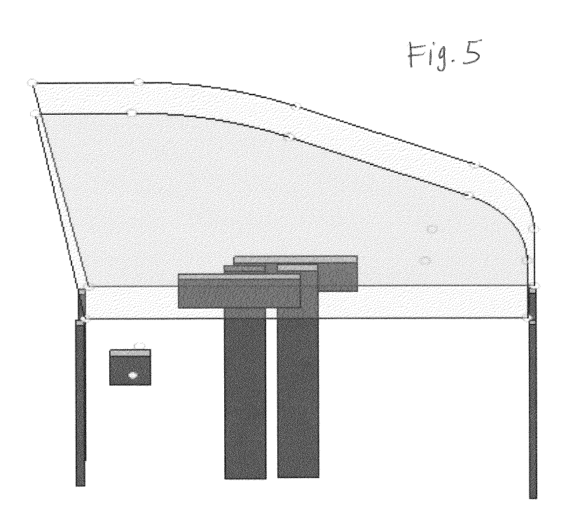

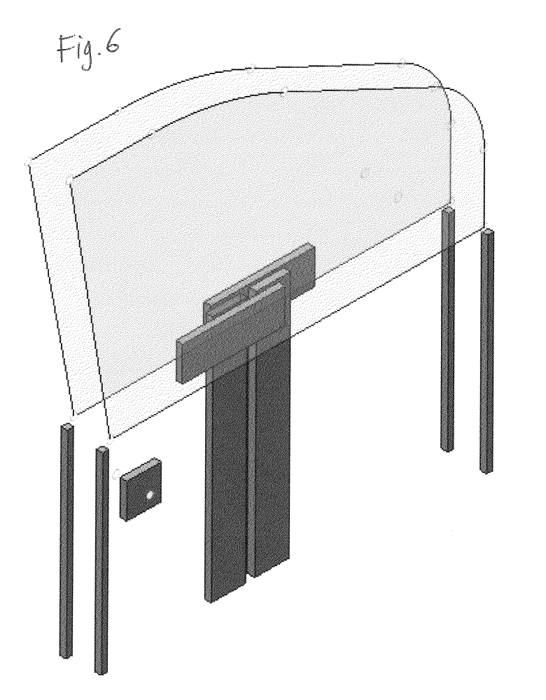

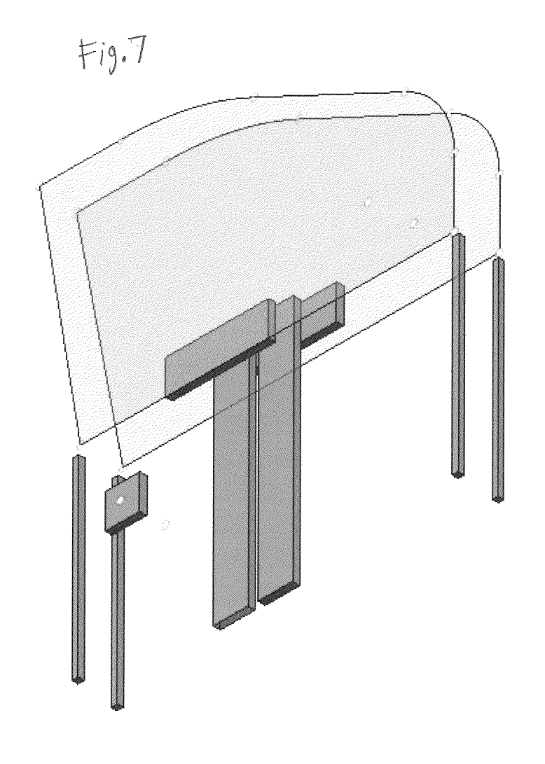

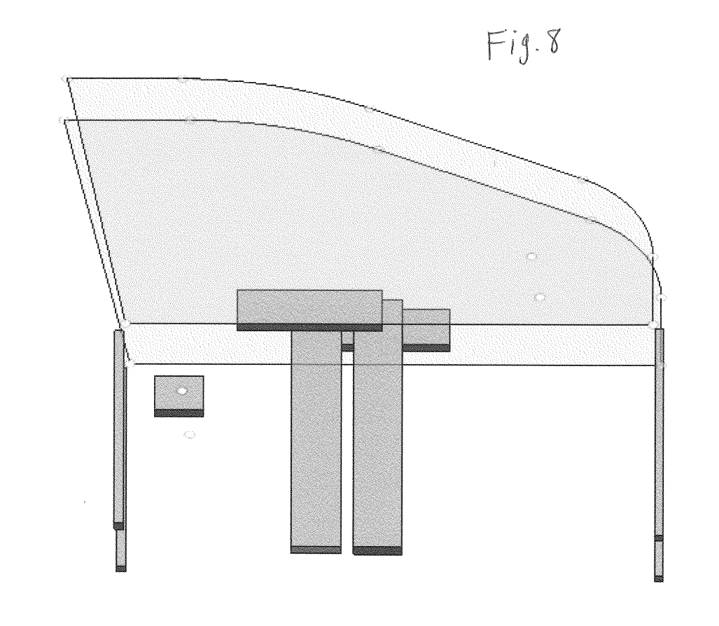

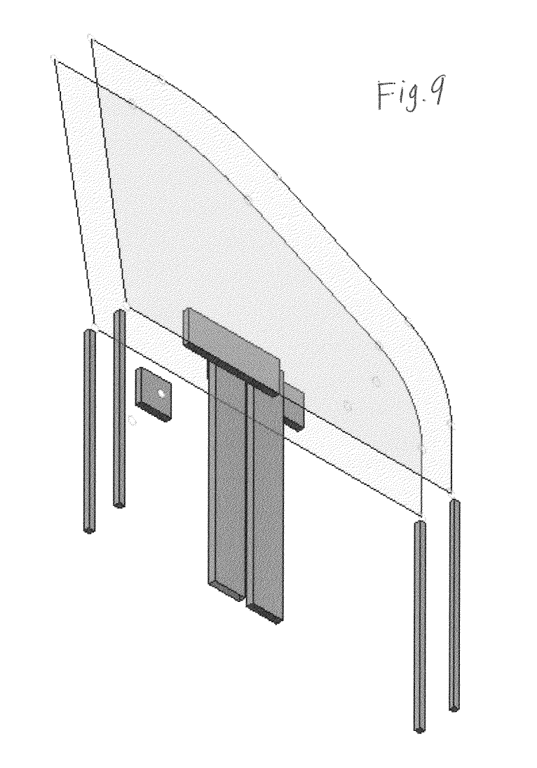

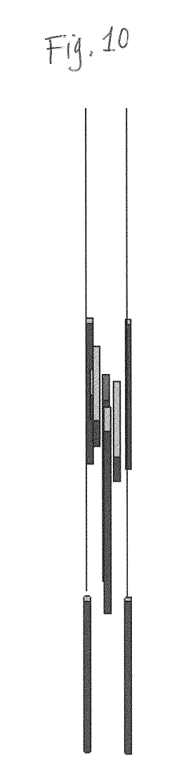

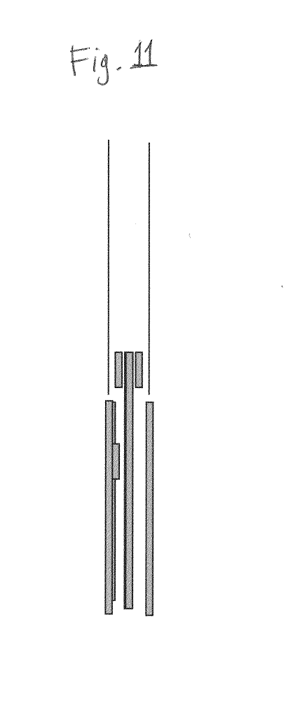

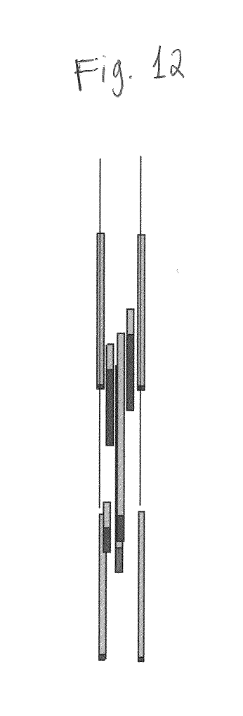

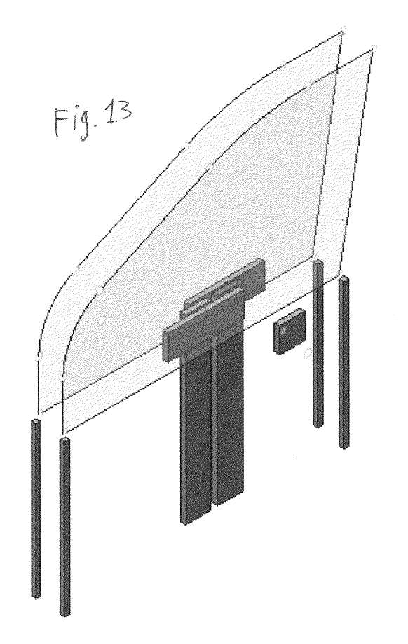

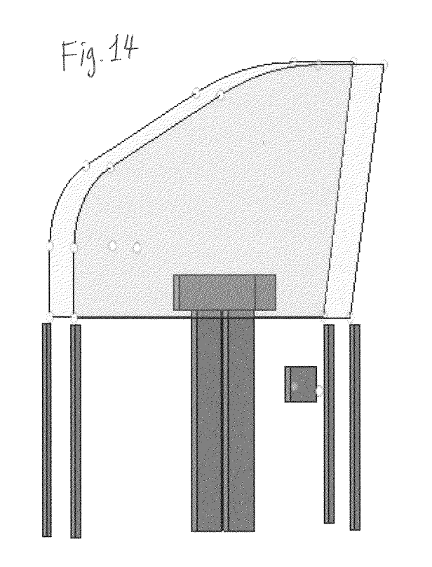

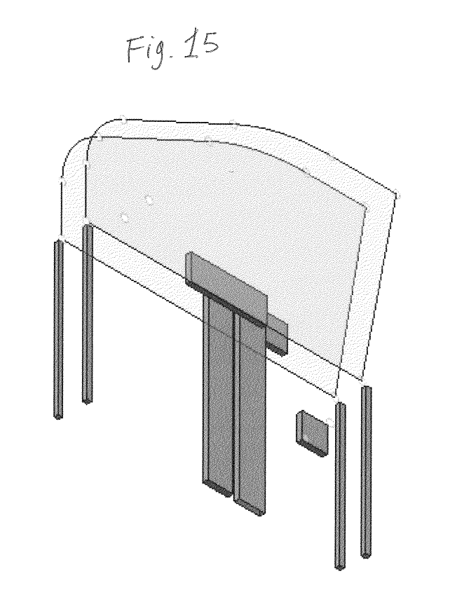

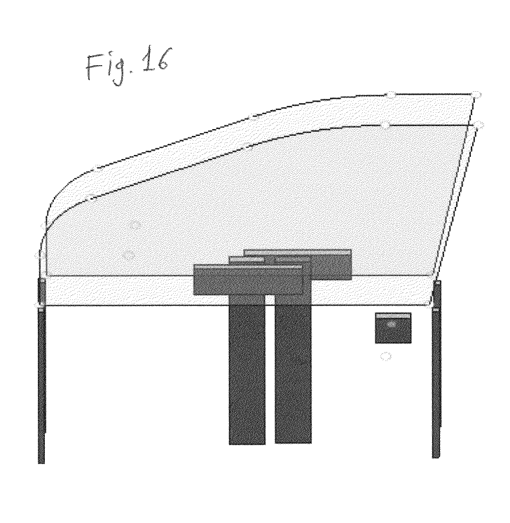

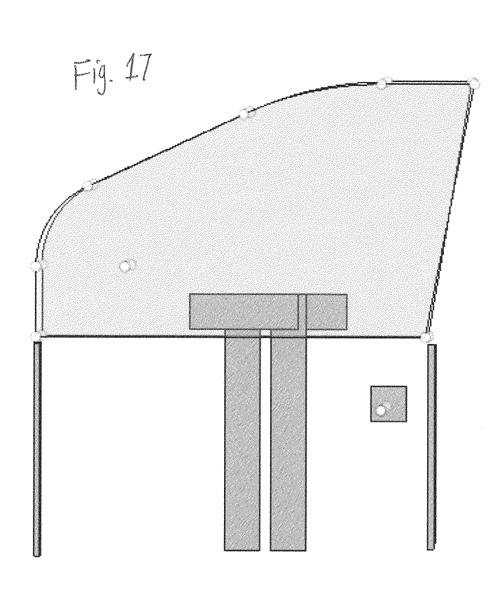

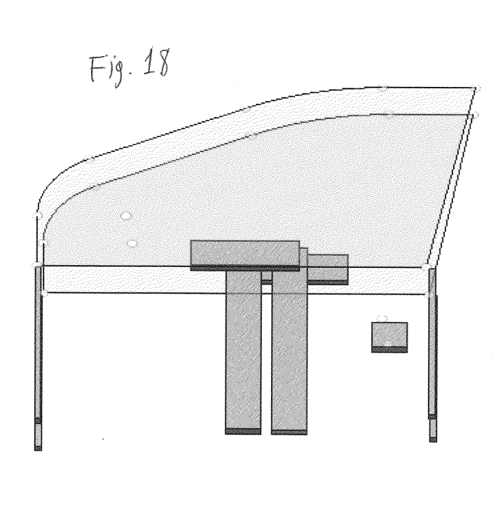

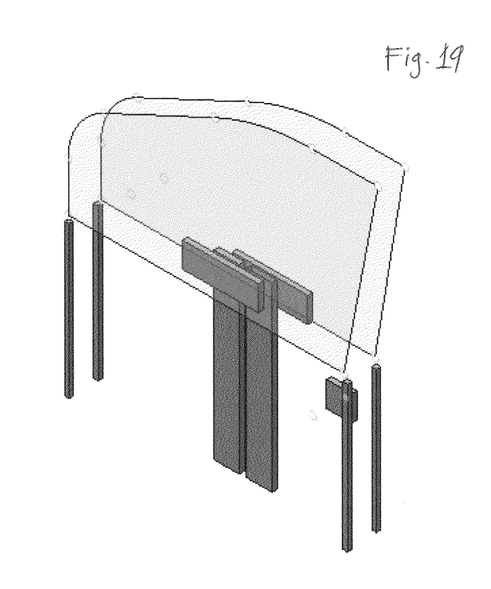

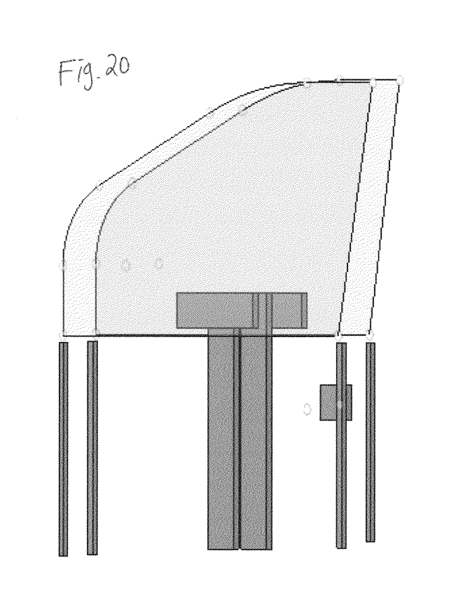

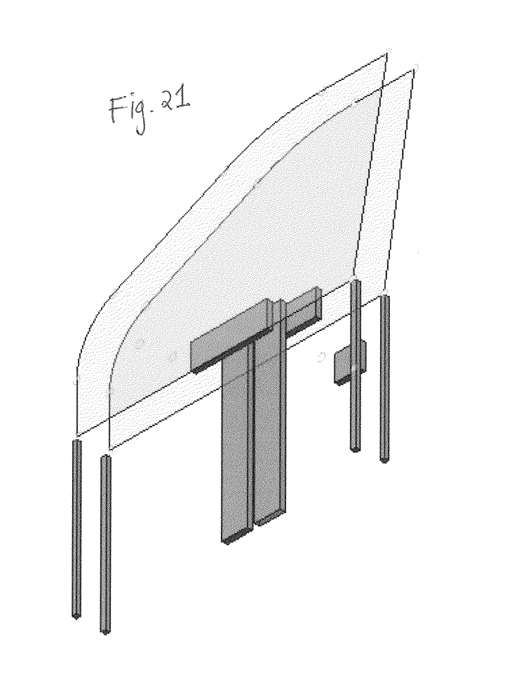

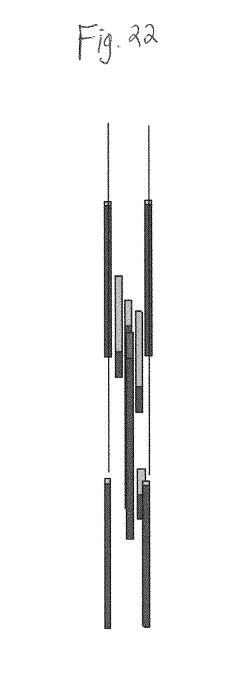

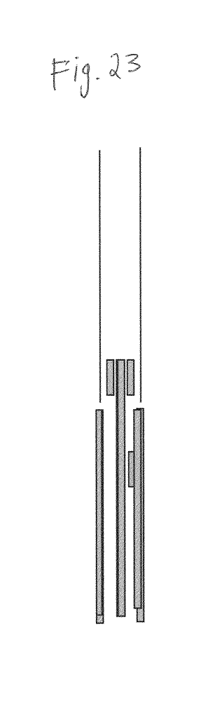

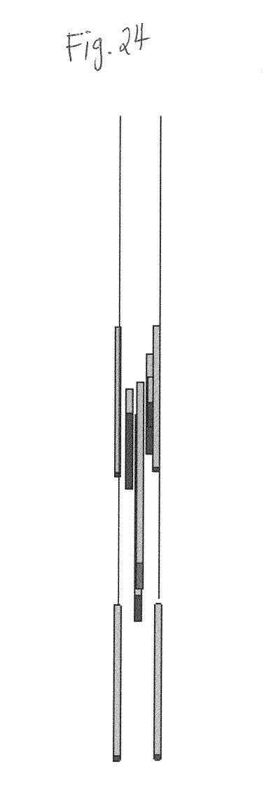

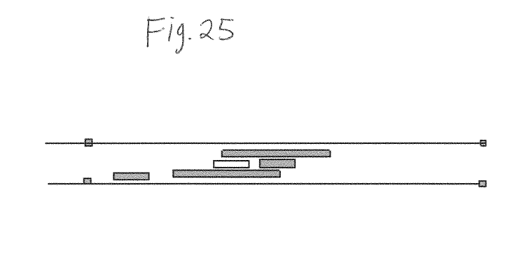

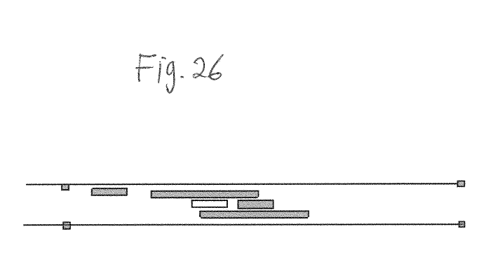

FIGS. 1 through 26 are a three dimensional, rotational design of the Vertical, I-Type Dual Power Window (DPW) system. FIGS. 1 through 9 are a view of the left door side I-Type DPW system from the inside of an automobile at different angles when both glasses are raised. They illustrate the two windows bolted to their corresponding regulators. The outer window is bolted to the outside facing I-Type regulator and the inner window is bolted to the inside facing I-Type regulator. Also illustrated are the outer window's front and back guide rails and the inner window's front and back guide rails. FIG. 11 is a view of it from the front. FIGS. 10 and 12 are a vertical rotation of FIG. 11. FIG. 10 is a 45 degree view from above the DPW system and FIG. 12 is a 45 degree view from below the DPW system. FIGS. 13 through 21 are a view of the left door side I-Type DPW system from the outside of an automobile at different angles. FIG. 23 is a view of it from the back. FIGS. 22 and 24 are a vertical rotation of FIG. 23. FIG. 22 is a 45 degree view from above and FIG. 24 is a 45 degree view from below. FIG. 25 is a view of the I-Type DPW system from above and FIG. 26 is a view from below.

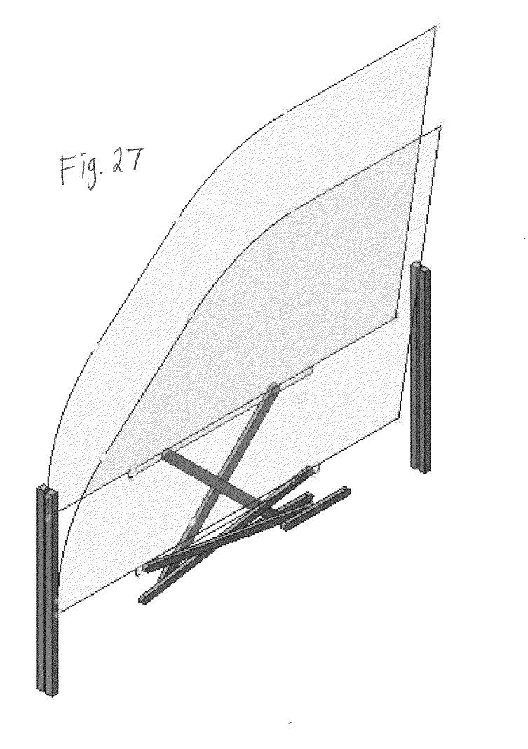

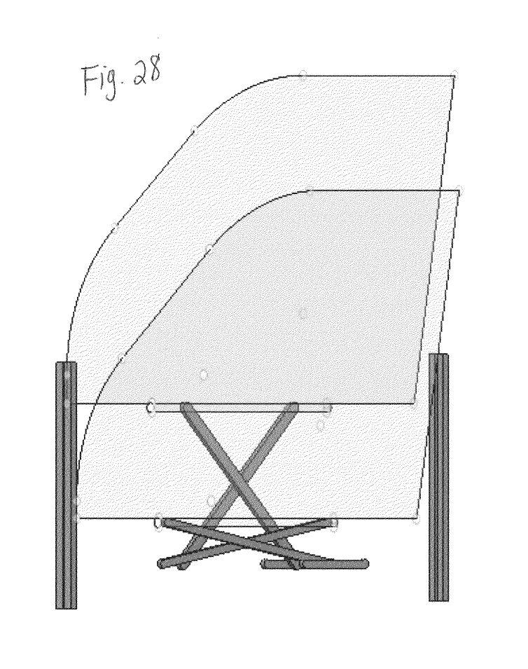

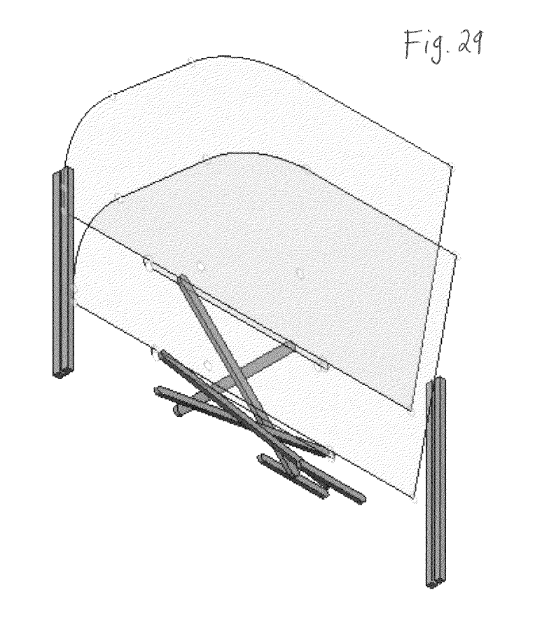

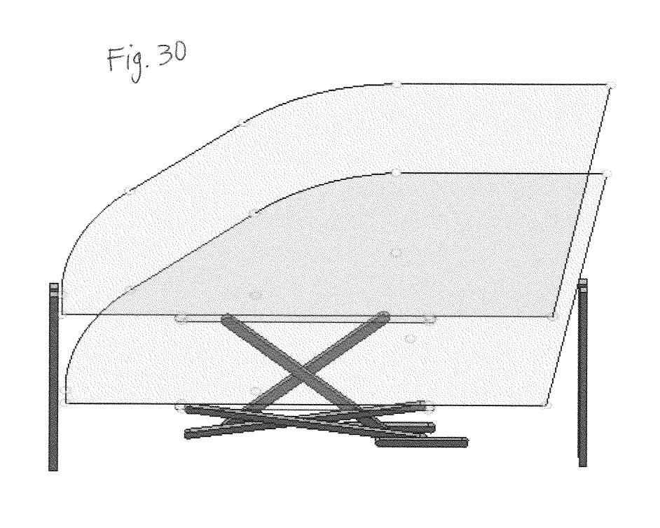

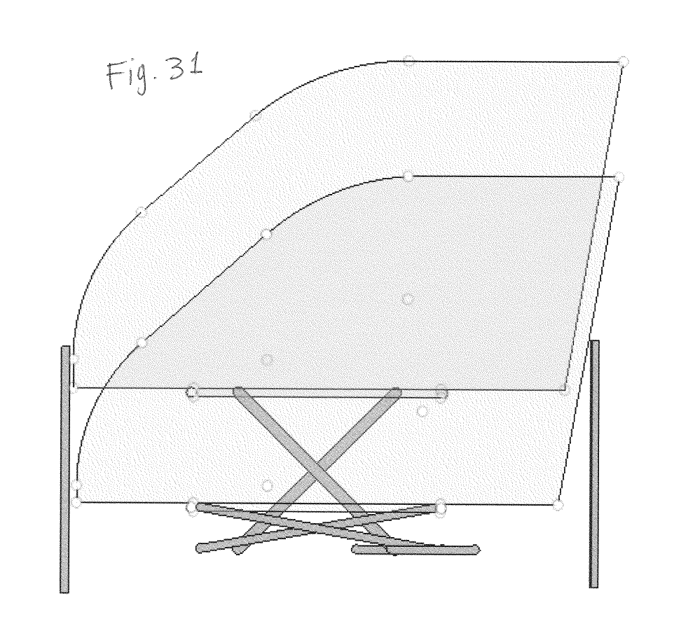

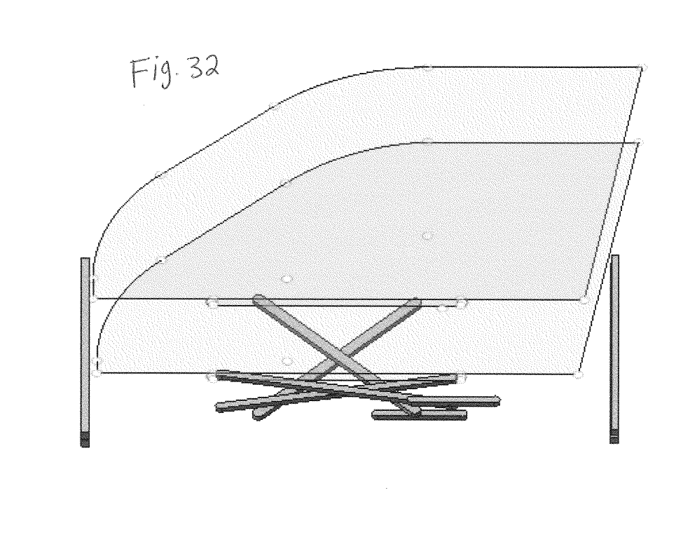

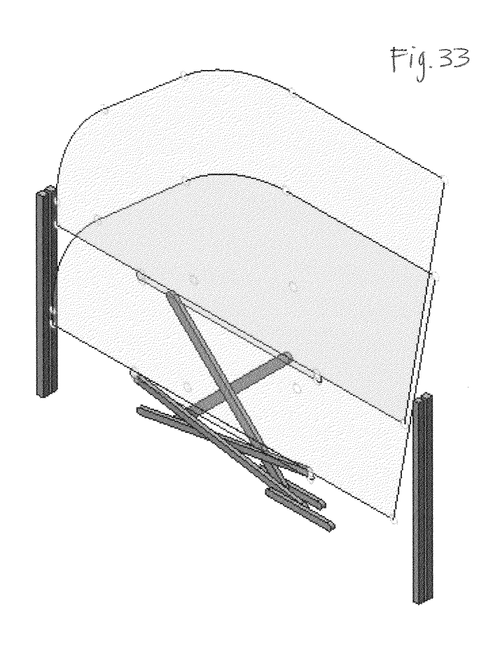

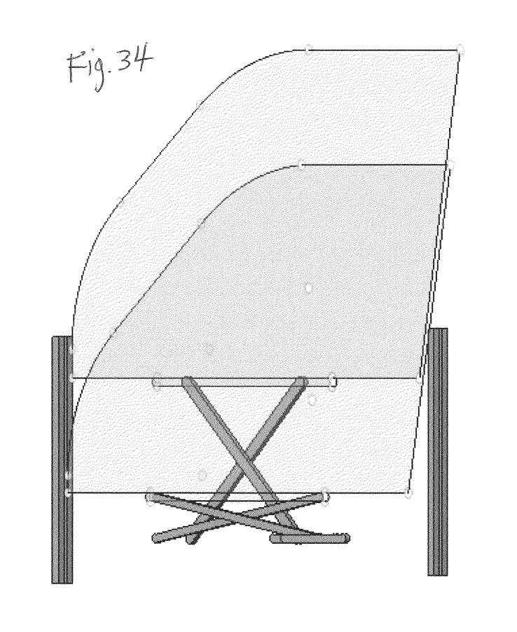

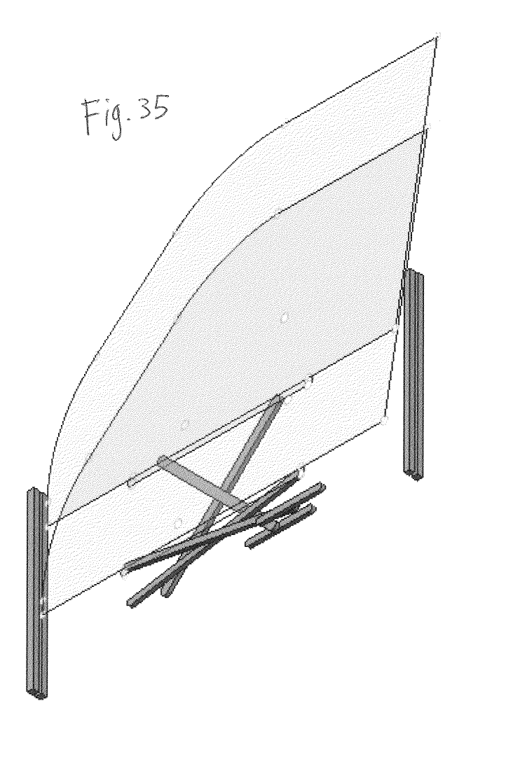

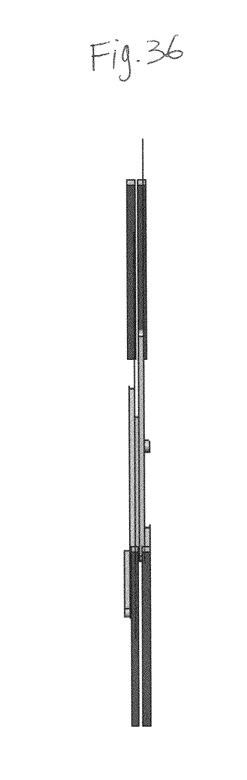

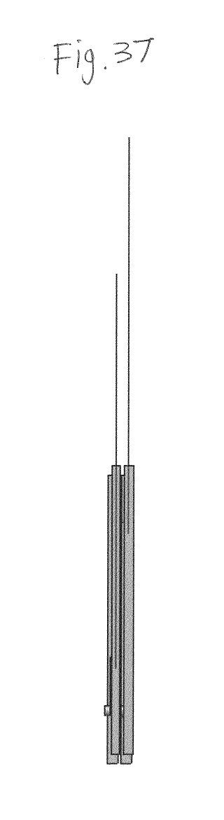

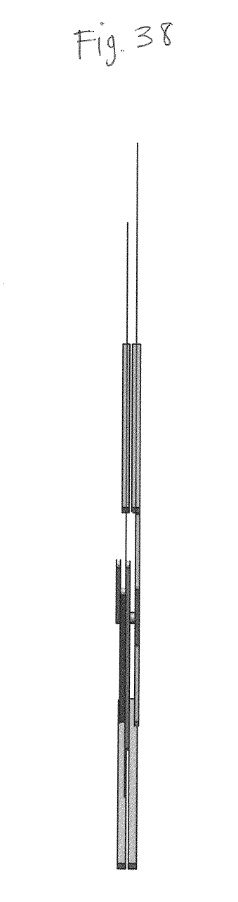

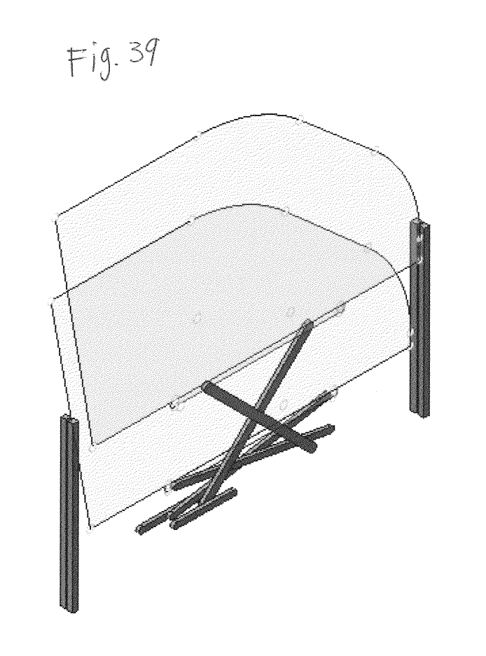

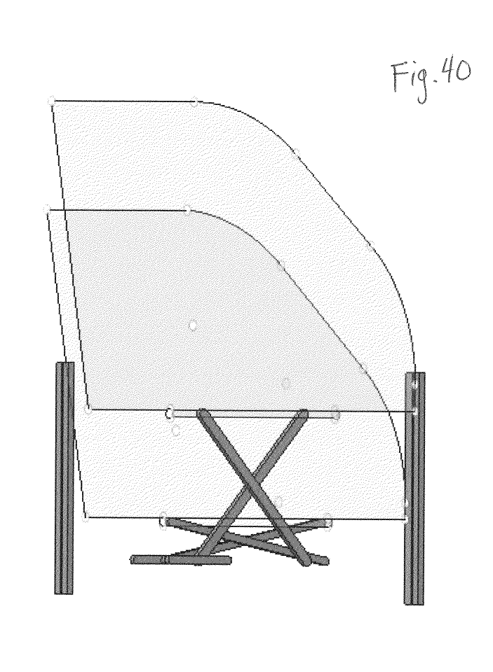

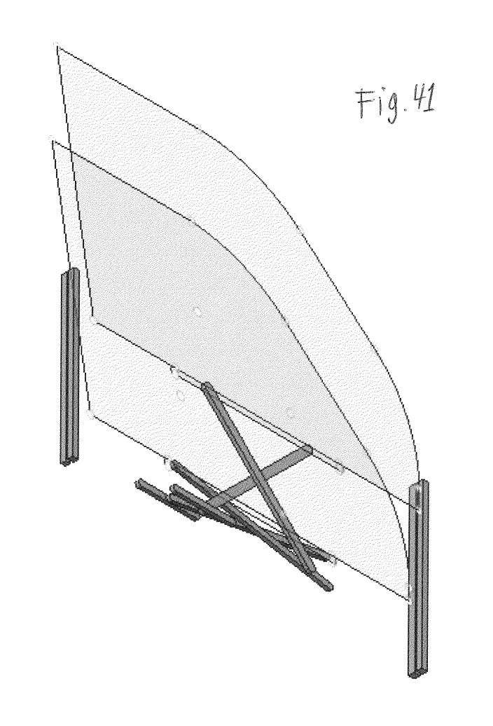

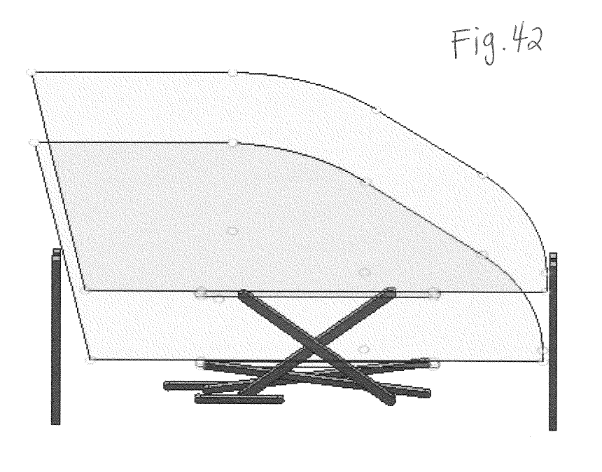

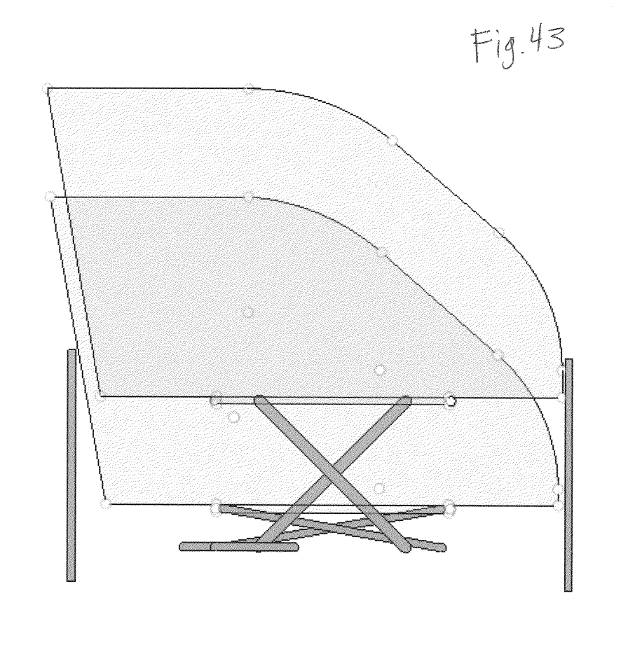

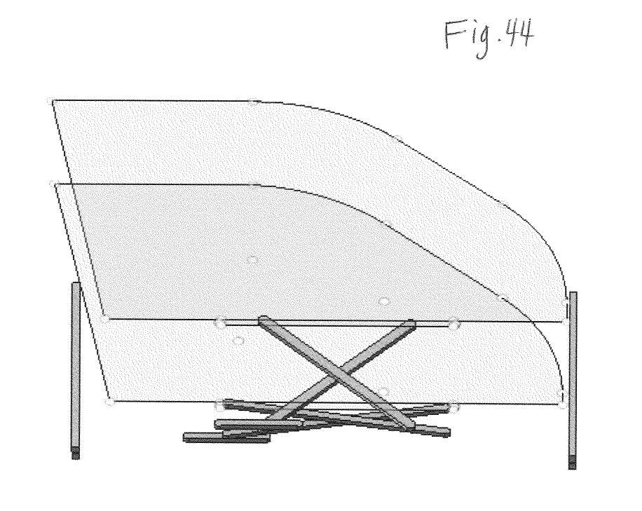

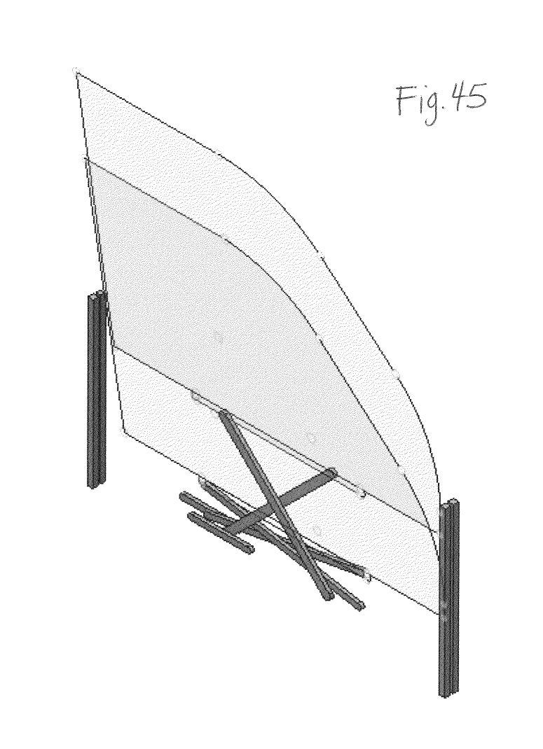

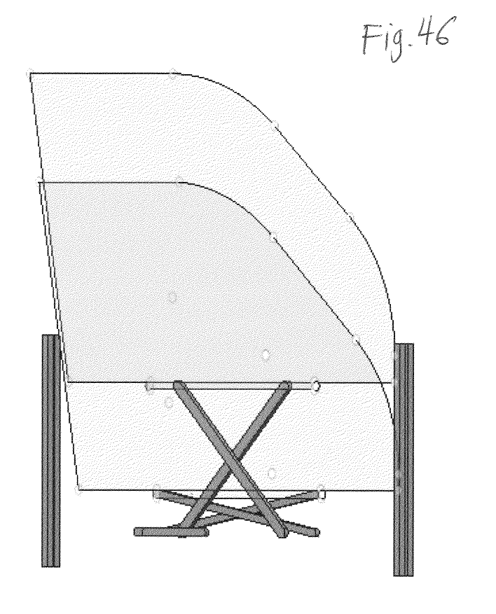

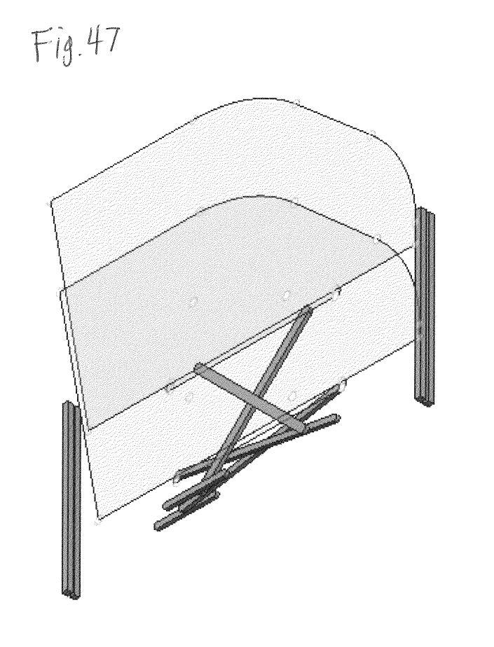

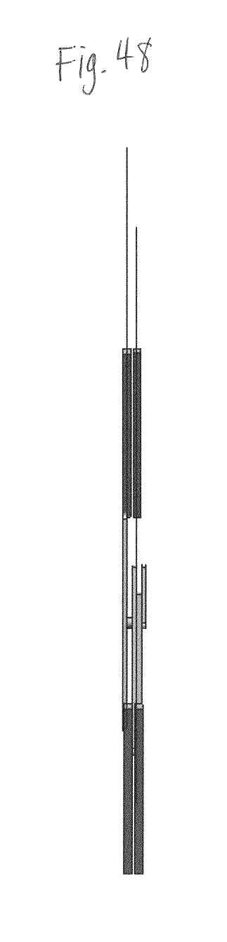

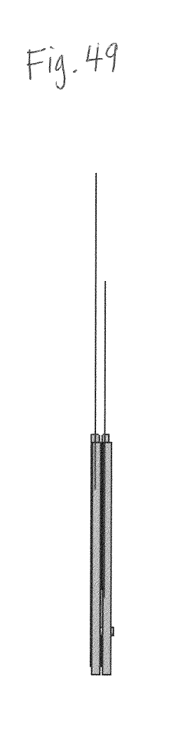

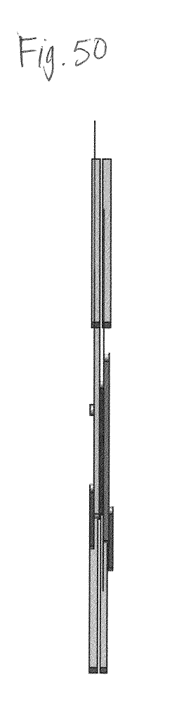

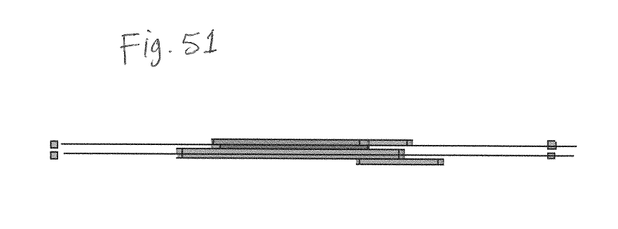

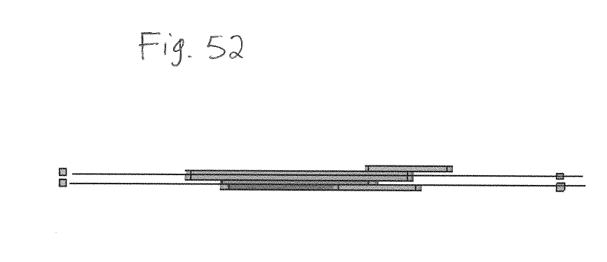

FIGS. 27 through 52 are a three dimensional, rotational design or embodiment of the Scissor, X-Type Dual Power Window (DPW) system. FIGS. 27 through 35 are a view of the left door side X-Type DPW system from the outside of an automobile at different angles when the outer glass is at a lowered position and the inner glass is at a raised position. It shows the two windows bolted to their corresponding regulators. The outer window, illustrated in a lowered position, is bolted to the outer X-Type regulator and the inner window, illustrated in a raised position, is bolted to the inner X-Type regulator. Also illustrated are the outer window's front and back guide rails and the inner window's front and back guide rails along with the inner and outer lower panel cams. FIG. 37 is a view of it from the front. FIGS. 36 and 38 are a vertical rotation of FIG. 37. FIG. 36 is a 45 degree view from above the DPW system and FIG. 38 is a 45 degree view from below the DPW system. FIGS. 39 through 47 are a view of the left door side X-Type DPW system from the inside of an automobile at different angles. FIG. 49 is view of it from the back. FIGS. 48 and 50 are a vertical rotation of FIG. 49. FIG. 48 is a 45 degree view from above and FIG. 50 is a 45 degree view from below. FIG. 51 is a view of the X-Type DPW system from above and FIG. 52 is a view from below.

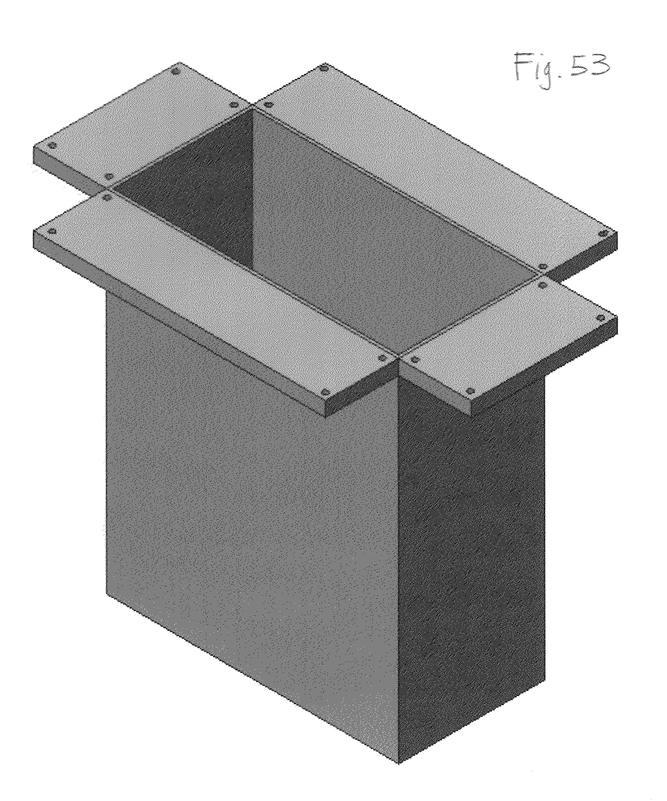

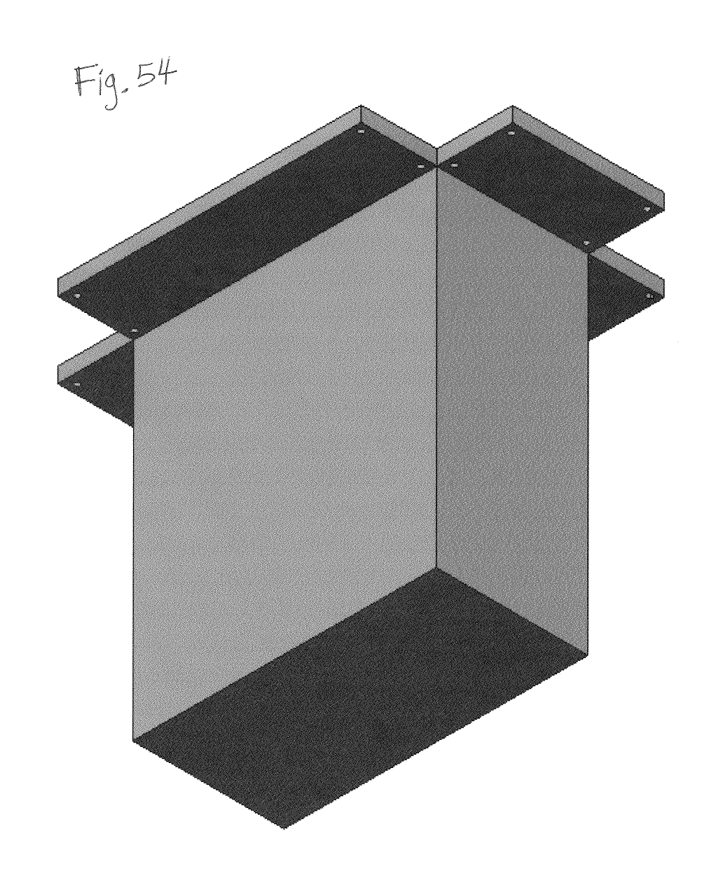

FIGS. 53 and 54 are a three dimensional, rotational design or embodiment of the Dual Power Window (DPW) Trunk Case showing its sixteen screw holes.

### DETAILED DESCRIPTION OF THE INVENTION

The Dual (day/night) Power Window system for automobiles, the DPW system is an improvement over the power window system because it provides two power window systems: an outer system with a clear window/glass and an inner system with a tinted window/glass, thus providing the passengers with the instant option of using the tinted window at times of too much ambient light or the clear window at times of too little ambient light. The DPW system is made of the same components utilized in the power window system, is manufactured utilizing the same processes as the power window system, and functions in the same manner as the power window system. The difference is that the DPW system is comprised of twice as many components as the power window system. The DPW system incorporates two: window glasses, window regulators, front guide rails, back guide rails, upper guide rails, upper panel cams, and lower panel cams. The DPW system utilizes one DPW Trunk Case which the power window system does not incorporate. Care of design must be taken into consideration in the spacing in between and around each of the two power window systems of the DPW system, depending on the specific automobile make and/or model. The DPW system must be constructed, per automobile model, in a way that will prevent friction or contact of each of the two power window systems with each other or with the outer or inner surfaces of the door. Spacing consideration must also be taken in order to prevent designing an excessively thick door.

1. The Dual (day/night) Power Window system (DPW) for automobiles is comprised of two window glasses per door. It has an outer/clear window and an inner/tinted window tinted to the automobile owner's liking. The inner window can be either tinted from the manufacturer or tinted by applying tinted paper to it. The DPW system is designed to give the occupant(s) of the automobile an instant choice on whether the occupant(s) want a clear, ambient view or if the occupant(s) wants to be protected from too much ambient light, whether or not the occupant is the driver or a passenger.

2. The (DPW) system for automobiles, according to claim 1, takes only seconds to switch over from clear window to tinted window, or vice versa, since all you have to do is to press the DPW button or switch on the control panel. The DPW switch transfers power to either the outer/clear or inner/tinted window so that it can be raised or lowered. When raised, the inner/tinted or dark window protects against too much ambient light whether or not the outer/clear window is fully or partially open or closed.

3. According to claim 2, on occasions when it is dark and the temperature is uncomfortably hot and the automobile only has tinted windows, the occupant(s) is/are going to have to decide whether s/he is going to keep her/his windows down, to allow ambient air to enter the vehicle while in motion, or bring the windows up to use the air conditioner in order to keep cool. Lowering the window will give a clear view and cool the occupant(s) by ambient air convection while the vehicle is in motion, but the occupant(s) might prefer to be cooled by the air conditioner whether the vehicle is in motion or not. The problem is that that may cause the occupant(s) to have to drive with tinted windows in the dark. That poses an automobile collision hazard, especially when other drivers forget to turn on their vehicle lights in the dark. The DPW system can bypass that problem because with it, the inner/tinted windows can be fully lowered and the outer/clear windows raised whenever it is too dark outside. With the outer/clear windows, the occupant(s) will still have the choice of using it partially up to allow ambient air to flow into the vehicle or to rise it fully in order to use the air conditioner.

4. The DPW system, according to claim 1, per automobile door, is comprised of: an outer/clear window, an inner/tinted window, two power window regulator assemblies (either the vertical I-type or the scissor X-type), two sets of window and regulator attaching nuts, bolts and rivets, two power window motors, two sets of front and back guide rails, two window bases, an outer, middle, and inner weather strip, a water shield on the inner side of all doors, and control panels for all DPW windows on the arm rests of all doors.

5. The Power Window Regulator Assemblies, according to claim 4, come in two types: a vertical I-type and a scissor X-type. Both types are illustrated in the accompanying drawings/figures.

6. The DPW system, according to claim 4, uses a control panel that has buttons or switches on it and is placed on the arm rests of each door, the dashboard, and or near the transmission stick. It is comprised of a) the DPW switch, b) the front/left/driver up and down switch, c) the front/right/passenger up and down switch, d) the back/left up and down switch, e) the back/right up and down switch, and f) the rear door up and down switch. On the DPW switch, to differentiate between when raising or lowering the outer/clear or inner/tinted window, the outer half of the DPW switch is white and the inner half is black. Another way to differentiate it is with the outer half of the button labeled (o) and the inner half labeled (i). The up and down switches are simply labeled up and down or (u) and (d).

7. According to claim 5, the I-type regulator DPW system operates by first pressing the DPW switch, when the ignition switch is in the ON state, to operate the outer/clear or inner/tinted window. Second, the window up or down switch is pressed. This activates the window motor which makes the window regulator, window base, and window go up or down the vertical I-beam and the front and rear guides. The X-type regulator DPW system operates by first pressing the DPW switch, when the ignition switch is in the ON state, to operate the outer/clear or inner/tinted window. Second, the window up or down switch is pressed. This activates the window motor, which connects the lower end of one of the “scissor” arms to the front guide, which makes the X-type window regulator raise or lower its “scissor” up or down the front and back guides. The rollers at the upper ends of the “scissor” arms will roll outward or inward on the window base while the window goes up or down the front and rear guides until either the occupant(s) lets go of the switch and the window comes to a stop, or until when the window reaches its lower or upper limit. The lower panel cam is attached to the bottom of the other “scissor” arm and guides it up and down the rear guide. Some models of the scissor X-type regulator reverse the location of the motor and the lower panel cam.

8. The DPW system, according to claim 4, is designed to keep the automobile door as thin as possible, without having outer regulator and inner regulator parts making contact or causing friction with each other. The automobile doors with vertical I-type regulators can physically be thinner than the automobile doors with scissor X-type regulators because the I-type regulators can be on the same vertical/door plane and the X-type regulators can not. The I-type outer regulator's window and components are placed facing the outer side of the door and the I-type inner regulator's window and components are placed facing the inner side of the door. The scissor X-type regulators have to be slightly thicker because the X-regulators can not be on the same vertical/door plane. The X-type outer regulator's window and components are placed on the outer side of the door and the X-type inner regulator's window and components are placed on the inner side of the door.

9. The DPW system, according to claim 4, should have the clear window outside and the tinted window inside in order to improve the design's ability to keep the components inside the door as dry as possible should it rain or snow. If the inner window is the tinted window, the outer/clear window could be shut should it rain or snow, in order to keep the components inside the door as dry as possible. If the outer window were the tinted window and it would rain or snow, you would have to close the outer/tinted window to keep the inside of the vehicle and components inside the door as dry as possible and that may cause it to become too dark for the occupants(s) to see on that dark, rainy, snowy, or cloudy day.

10. The DPW system, according to claim 4, can be applied to a 5th/back door on a 4-door car or a 3rd/back door on a 2-door car, whether the door opens upward or downward. If the DPW system is to be used on an automobile that has a trunk behind the back windshield, a fixed DPW Trunk Case would have to be placed inside the trunk in order to protect the rear windows from coming down onto an object inside the trunk or if the window(s) is/are down, from having an object in the trunk strike the window(s) while the automobile is in motion. Another option would be to have the outer/clear/back window fixed and the inner/tinted/back window be able to be lowered or raised electronically. In order not to substantially reduce the size of the trunk, the back door DPW system and window would have to be as close to vertical as possible. The greater its angle, or the more horizontal it is, the smaller the trunk will be.

11. The DPW Trunk Case, According to claim 10, is a hollow, rectangular box made out of low-cost, impact-resisting materials whose dimensions allow the back windows to enter and exit it from an opening on the top of the case. It is bolted to the upper rear surface of the trunk.

12. The DPW system, according to claim 4, can be applied to the sun-roof systems of automobiles.

13. The DPW system, according to claim 7, can aid the occupant(s) in locations and situations where it is illegal to use tinted windows on an automobile. Should a law enforcement official detain the occupant(s) for driving with tinted windows, the occupant(s) can physically show the official that the automobile is equipped with the DPW system and instantly switch over to all clear windows. If the occupant(s) know that they are going to approach such a location, they can switch over to all clear windows before they arrive there.
